(19) United States
(12) Patent Application Publication
(10) Pub. No.: US 2026/0292543 A1
(43) Pub. Date: Sep. 24, 2026

(54) METHOD AND USER EQUIPMENT TO IMPROVE EMERGENCY SERVICES AT AND AFTER DISCONTINUOUS COVERAGE

(71) Applicant: MEDIATEK SINGAPORE PTE. LTD., Singapore (SG)

(72) Inventors: Puneet ., Bengaluru (IN); Marko NIEMI, Oulu (FI)

(73) Assignee: MEDIATEK SINGAPORE PTE. LTD., Singapore (SG)

(21) Appl. No.: 19/474,221

(22) PCT Filed: Jun. 24, 2024
(86) PCT No.: PCT/CN2024/100937

§ 371 Date: Oct. 10, 2025

(30) Foreign Application Priority Data
Jul. 10, 2023 (IN) 202321046285
Aug. 28, 2023 (IN) 202321057690

(51) Int. Cl. H04W 24/02; H04W 48/18; H04W 60/04; H04W 76/28; H04W 76/50

(52) U.S. Cl. CPC H04W 24/02; H04W 48/18; H04W 60/04; H04W 76/28; H04W 76/50

(57) ABSTRACT

A method to improve emergency services at and after discontinuous coverage, which is applied to user equipment (UE), includes the following steps. A non-access stratum (NAS) signaling wait timer is run for a duration of time. An emergency protocol data unit (PDU) session is established during the duration of time. Alternatively, an emergency services fallback procedure is performed during the duration of time. An NAS signaling is initiated.

### CROSS REFERENCE TO RELATED APPLICATIONS

This Application claims priority of India Patent Application No. 202321046285, filed on Jul. 10, 2023, and India. Patent Application No. 202321057690, filed on Aug. 28, 2023, the entirety of which are incorporated by reference herein.

### BACKGROUND OF THE INVENTION

### Field of the Invention

The present invention relates to a method for 5G NR operation in discontinuous coverage, and, in particular, to a method and a UE to improve high-priority services and emergency services at and after discontinuous coverage.

### Description of the Related Art

A deployment option for satellite E-UTRAN or NG-RAN access is provided by current technology, in which shorter periods of satellite E-UTRAN or NG-RAN access radio coverage are followed by longer periods of satellite E-UTRAN or NG-RAN access coverage gaps. During coverage gaps, the access stratum may be deactivated. These coverage gaps are called discontinuous coverage.

When a discontinuous coverage non-access stratum (NAS) signaling wait timer is running, the UE is not allowed to perform a registration procedure when the UE is a UE configured for a high-priority access in a selected public land mobile network (PLMN). A high-priority access service procedure will be triggered upon a random timer expiry which will delay the processing of the high-priority access. This delay will have an impact on user experience in case of urgency.

When the discontinuous coverage NAS signaling wait timer is running, the UE is not allowed to perform the registration procedure, an emergency services fallback procedure is not allowed to trigger. It will delay emergency call establishment.

### BRIEF SUMMARY OF THE INVENTION

An embodiment of the present invention provides a method to improve emergency services at and after discontinuous coverage. The method is applied to user equipment (UE). The method includes the following steps. A non-access stratum (NAS) signaling wait timer is run for a duration of time. An emergency protocol data unit (PDU) session is established during the duration of time. An emergency services fallback procedure is performed during the duration of time. An NAS signaling is initiated.

According to the method described above, the NAS signaling is a mobility registration update procedure or a tracking area updating procedure.

The method further includes the following steps. A request from an upper layer to perform the emergency services fallback procedure is received. For the emergency services, an evolved universal terrestrial radio access network (E-UTRAN), a GSM EDGE radio access network (GERAN), or a UMTS terrestrial radio access network (UTRAN) is selected. Alternatively, an initial registration for the emergency services is performed. Alternatively, the upper layer is informed about a failure of the emergency services fallback procedure.

The method further includes the following steps. The UE has a pending emergency services fallback procedure. An evolved universal terrestrial radio access network (E-UTRAN), a GSM EDGE radio access network (GERAN), or a UMTS terrestrial radio access network (UTRAN) is selected for the emergency services. Alternatively, an initial registration is performed for the emergency services. Alternatively, the upper layer is informed about a failure of the pending emergency services fallback procedure.

The method further includes the following steps. The UE has an established emergency protocol data unit (PDU) session. An evolved universal terrestrial radio access network (E-UTRAN), a GSM EDGE radio access network (GERAN), or a UMTS terrestrial radio access network (UTRAN) is selected for the emergency services. Alternatively, an initial registration for the emergency services is performed. Alternatively, the upper layer is informed about a failure of the established emergency PDU session.

According to the method described above, the duration that the NAS signaling wait timer is running starts with a random value up to and including a stored maximum time offset value upon returning in coverage of a tracking area (TA) in a current registration after being out of coverage due to discontinuous coverage.

The method further includes the following steps. The UE is configured for a high-priority access in a selected PLMN. The UE receives and has stored maximum NAS signaling wait time. The UE does not use the maximum NAS signaling wait time; nor does it start the NAS signaling wait timer using the maximum NAS signaling wait time.

An embodiment of the present invention also provides a UE to improve emergency services at and after discontinuous coverage. The UE includes a processor. The processor runs an NAS signaling wait timer for a duration of time, establishes an n emergency protocol data unit (PDU) session during the duration of time, or performs an emergency services fallback procedure during the duration of time, and initiates an NAS signaling.

According to the UE described above, after the NAS signaling wait timer has begun running, the processor receives a request from an upper layer to perform the emergency services fallback procedure. The processor selects an E-UTRAN, a GERAN, or an UTRAN for the emergency services. Alternatively, the processor performs an initial registration for the emergency services. Alternatively, the processor informs the upper layer of a failure of the emergency services fallback procedure.

According to the UE described above, after the NAS signaling wait timer has begun running, the processor has a pending emergency services fallback procedure. The processor selects an E-UTRAN, a GERAN, or an UTRAN for the emergency services. Alternatively, the processor performs an initial registration for the emergency services. Alternatively, the processor informs the upper layer of a failure of the pending emergency services fallback procedure.

According to the UE described above, after the discontinuous coverage NAS signaling wait timer has begun running, the processor has an established emergency PDU session. The processor selects an E-UTRAN, a GERAN, or an UTRAN for the emergency services. Alternatively, the processor performs an initial registration for the emergency services. Alternatively, the processor informs the upper layer of a failure of the established emergency PDU session.

According to the UE described above, the NAS signaling is a mobility registration update procedure or a tracking area updating procedure According to the UE described above, the duration that the NAS signaling wait timer is running starts with a random value up to and including a stored maximum time offset value upon returning in coverage of a tracking area (TA) in a current registration after being out of coverage due to discontinuous coverage.

According to the UE described above, the processor is configured for a high-priority access in a selected PLMN. The processor receives and has stored the maximum NAS signaling wait time. The processor does not use the maximum NAS signaling wait time; nor does it start the NAS signaling wait timer using the maximum NAS signaling wait time.

### BRIEF DESCRIPTION OF THE DRAWINGS

The present invention can be more fully understood by reading the subsequent detailed description and examples with references made to the accompanying drawings, wherein:

FIG. 1 shows a flow chart of a method to improve emergency services at and after discontinuous coverage in accordance with some embodiments of the present invention;

FIG. 2 shows a flow chart of the method to improve emergency services at and after discontinuous coverage in FIG. 1 in accordance with some embodiments of the present invention;

FIG. 3 shows a flow chart of the method to improve emergency services at and after discontinuous coverage in FIG. 1 in accordance with some embodiments of the present invention;

FIG. 4 shows a flow chart of the method to improve emergency services at and after discontinuous coverage in FIG. 1 in accordance with some embodiments of the present invention;

FIG. 5 shows a flow chart of the method to improve emergency services at and after discontinuous coverage in FIG. 1 in accordance with some embodiments of the present invention;

FIG. 6 shows a schematic diagram of a method to improve high-priority services at and after discontinuous coverage in accordance with some embodiments of the present invention; and

FIG. 7 shows a schematic diagram of a communication system 700 in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ” . Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, “third”, “fourth”, “fifth”, and “sixth” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

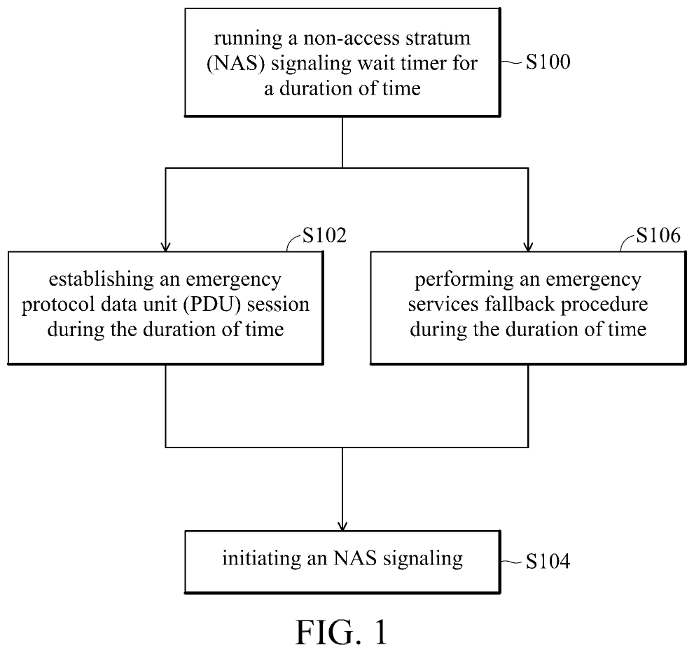

FIG. 1 shows a flow chart of a method to improve emergency services at and after discontinuous coverage in accordance with some embodiments of the present invention. The method to improve emergency services at and after discontinuous coverage is applied to user equipment (UE). In some embodiments, the UE may be, for example, a laptop, a tablet, a smart phone, a smart watch, etc., but the present invention is not limited thereto. As shown in FIG. 1, the method to improve emergency services at and after discontinuous coverage includes the following steps. A non-access stratum (NAS) signaling wait timer is run for a duration of time (step S100). An emergency protocol data unit (PDU) session is established during the duration of time (step S102) or an emergency services fallback procedure is performed during the duration of time (step S106). An NAS signaling is initiated (step S104).

In some embodiments of step S100, if for the discontinuous coverage the UE has stored maximum NAS signaling wait time, upon returning in coverage after being out of coverage due to the discontinuous coverage, the UE sets a maximum NAS signaling wait time value to a random value up to and including the stored discontinuous coverage maximum NAS signaling wait time for the selected PLMN and satellite next generation radio access network (NG-RAN) radio access technology (RAT) type, and starts the NAS signaling wait timer. In step S102, the UE establishes the emergency PDU session during the duration of time. In step S106, the UE performs the emergency services fallback procedure during the duration of time. In some embodiments, the UE may perform step S102 or S106 after step S100 is performed. Next, in step S104, the UE initiates an NAS signaling. In some embodiments, the NAS signaling is a mobility registration procedure or a tracking area (TA) updating procedure. In some embodiments, the duration that the NAS signaling wait timer is running starts with a random value up to and including a stored maximum time offset value upon returning in coverage of a TA in a current registration after being out of coverage due to discontinuous coverage.

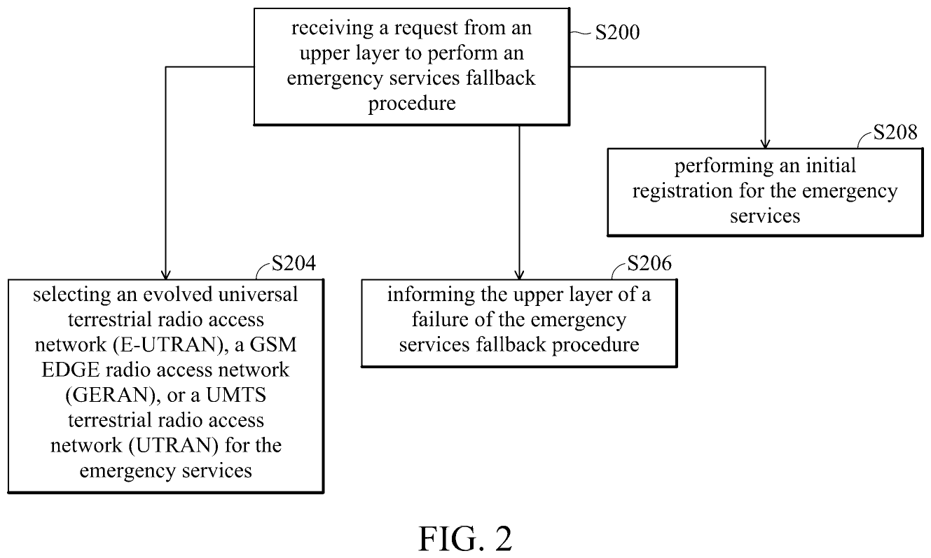

FIG. 2 shows a flow chart of the method to improve emergency services at and after discontinuous coverage in FIG. 1 in accordance with some embodiments of the present invention. As shown in FIG. 2, the method to improve emergency services at and after discontinuous coverage includes the following steps. A request from an upper layer is received to perform an emergency services fallback procedure (step S200). Alternatively, an evolved universal terrestrial radio access network (E-UTRAN), a GSM EDGE radio access network (GERAN), or a UMTS terrestrial radio access network (UTRAN) is selected for the emergency services (step S204). Alternatively, an initial registration for the emergency services is performed (step S208). Alternatively, the upper layer is informed about a failure of the emergency services fallback procedure (S206).

In step S200, the UE receives the request from the upper layer to perform the emergency services fallback procedure. In some embodiments, after step S200 is performed, the UE may execute at least one of steps S204, S206 and S208. For example, the UE is attempted to select an E-UTRAN, a GERAN, or an UTRAN for the emergency services in step S204. The UE performs an initial registration for the emergency services in step S208. The UE informs a failure of the emergency services fallback procedure, or of the signaling procedure, or of the registration procedure to the upper layer in step S206.

In some embodiments, the UE does not initiate any NAS signaling on the NG-RAN RAT type and the selected PLMN while the discontinuous coverage NAS signaling wait timer is running. The UE stops the NAS signaling wait timer and initiates NAS signaling if the UE receives the paging message or is performing the emergency services fallback procedure.

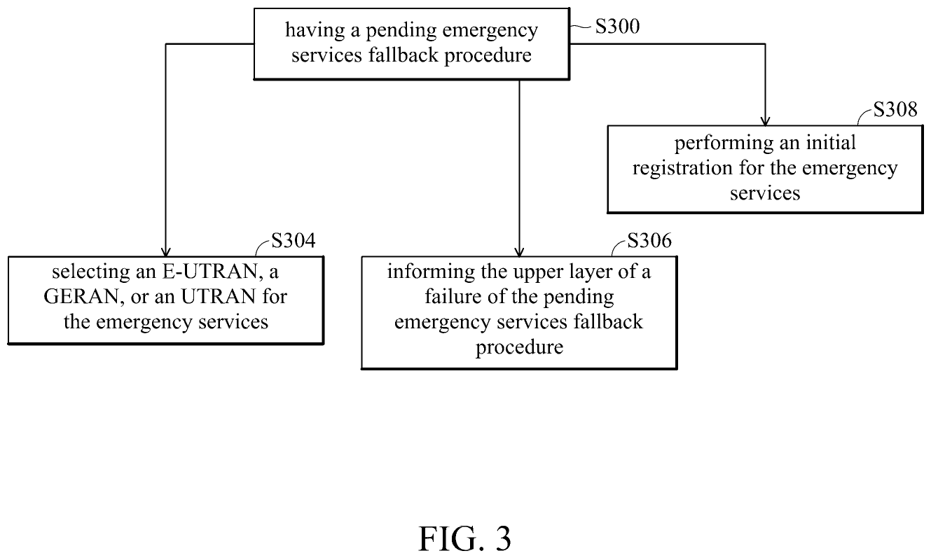

FIG. 3 shows a flow chart of the method to improve emergency services at and after discontinuous coverage in FIG. 1 in accordance with some embodiments of the present invention. As shown in FIG. 3, the method to improve emergency services at and after discontinuous coverage includes the following steps. The UE has a pending emergency services fallback procedure (step S300). An E-UTRAN, a GERAN, or an UTRAN is selected for the emergency services (step S304). Alternatively, an initial registration for the emergency services is performed (step S308). Alternatively, the upper layer is informed about a failure of the pending emergency services fallback procedure (step S306).

In step S300, the UE has a pending emergency services fallback procedure. In some embodiments, after step S300 is performed, the UE may execute at least one of steps S304, S306 and S308. For example, the UE is attempted to select an E-UTRAN, a GERAN, or an UTRAN for the emergency services in step S304. The UE performs an initial registration for the emergency services in step S308. The UE informs a failure of the pending emergency services fallback procedure, or of the signaling procedure, or of the registration procedure to the upper layer in step S306.

In some embodiments, the UE does not initiate any NAS signaling on the NG-RAN RAT type and the selected PLMN while the NAS signaling wait timer is running. The UE stops the NAS signaling wait timer and initiates NAS signaling if the UE has the pending emergency services.

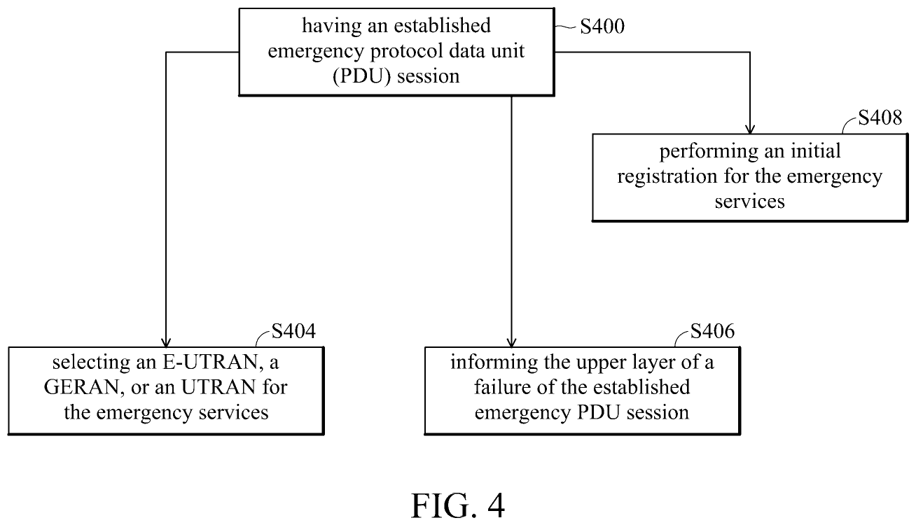

FIG. 4 shows a flow chart of the method to improve emergency services at and after discontinuous coverage in FIG. 1 in accordance with some embodiments of the present invention. As shown in FIG. 4, the method to improve emergency services at and after discontinuous coverage includes the following steps. The UE has an established emergency protocol data unit (PDU) session (step S400). Alternatively, an E-UTRAN, a GERAN, or an UTRAN is selected for the emergency services (step S404). Alternatively, an initial registration for the emergency services is performed (step S408). Alternatively, the upper layer is informed about a failure of the established emergency PDU session (step S406).

In step S400, the UE has an established emergency PDU session. In some embodiments, after step S400 is performed, the UE may execute at least one of steps S404, S406 and S408. For example, the UE is attempted to select an E-UTRAN, a GERAN, or an UTRAN for the emergency services in step S404. The UE performs an initial registration for the emergency services in step S408. The UE informs the failure of the established emergency PDU session, or of the signaling procedure, or of the registration procedure to the upper layer in step S406.

In some embodiments, the UE does not initiate any NAS signaling on the NG-RAN RAT type and the selected PLMN while the NAS signaling wait timer is running. The UE stops the NAS signaling wait timer and initiates NAS signaling if the UE enters a tracking area identity (TAI) outside a registration area.

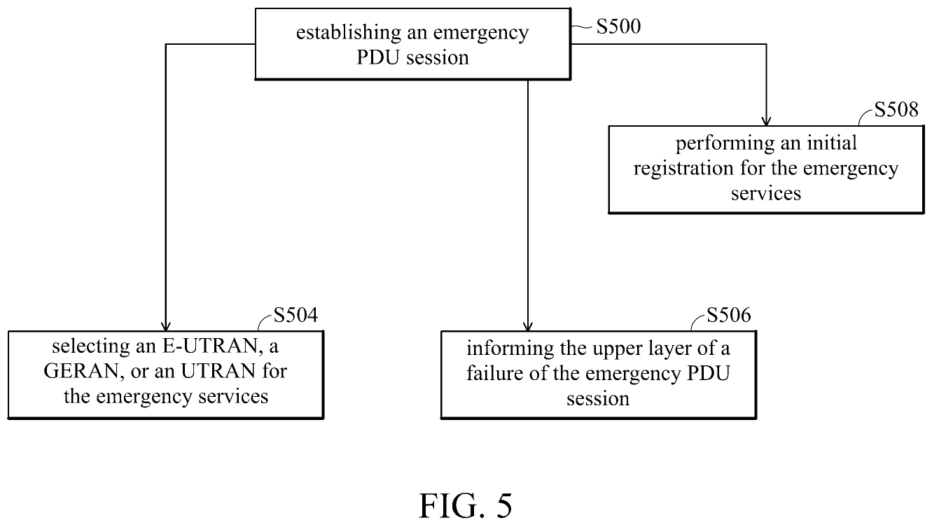

FIG. 5 shows a flow chart of the method to improve emergency services at and after discontinuous coverage in FIG. 1 in accordance with some embodiments of the present invention. As shown in FIG. 5, the method to improve emergency services at and after discontinuous coverage includes the following steps. An emergency PDU session is established (step S500). Alternatively, an evolved universal terrestrial radio access network (E-UTRAN), a GSM EDGE radio access network (GERAN), or a UMTS terrestrial radio access network (UTRAN) is selected for the emergency services (step S504). Alternatively, an initial registration for the emergency services is performed (step S508). Alternatively, the upper layer is informed a failure of the emergency PDU session (step S506).

In step S500, the UE establishes an emergency PDU session. In some embodiments, after step S500 is performed, the UE may execute at least one of steps S504, S506 and S508. For example, the UE is attempted to select an E-UTRAN, a GERAN, or an UTRAN for the emergency services in step S504. The UE performs an initial registration for the emergency services in step S508. The UE informs the failure of the emergency PDU session, or of the signaling procedure, or of the registration procedure to the upper layer in step S506.

In some embodiments, the UE does not initiate any NAS signaling on the NG-RAN RAT type and the selected PLMN while the NAS signaling wait timer is running. The UE stops the NAS signaling wait timer and initiates NAS signaling if the UE is establishing an emergency PDU session.

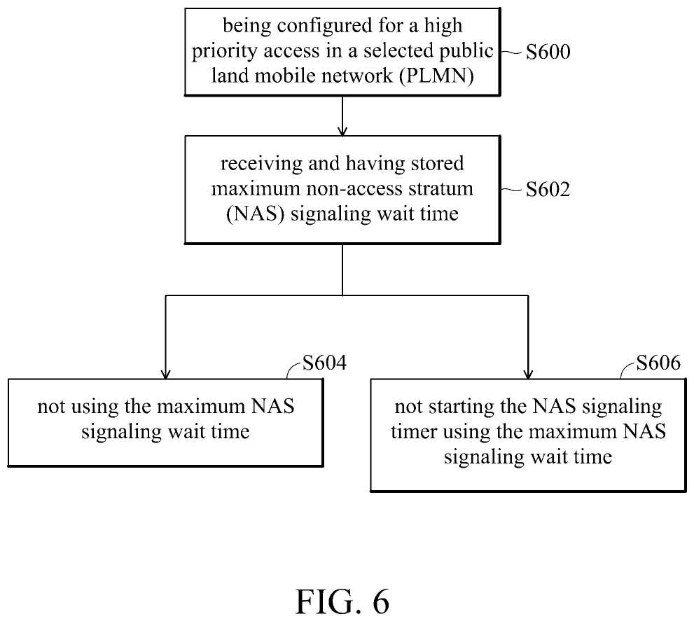

FIG. 6 shows a schematic diagram of a method to improve high-priority services at and after discontinuous coverage in accordance with some embodiments of the present invention. The method to improve high-priority services at and after discontinuous coverage is applied to user equipment (UE). In some embodiments, the UE may be, for example, a laptop, a tablet, a smart phone, a smart watch, etc., but the present invention is not limited thereto. As shown in FIG. 6, the method to improve high-priority services at and after discontinuous coverage includes the following steps. The UE is configured for a high-priority access in a selected PLMN (step S600). The UE receives and has stored the maximum non-access stratum (NAS) signaling wait time (step S602). The UE does not use the maximum NAS signaling wait time (step S604). Alternatively, the UE does not start the NAS signaling wait timer using the maximum NAS signaling wait time (step S606). The main difference between the methods in FIG. 6 and FIG. 1 is that, in FIG. 6, the NAS signaling wait timer is never started up.

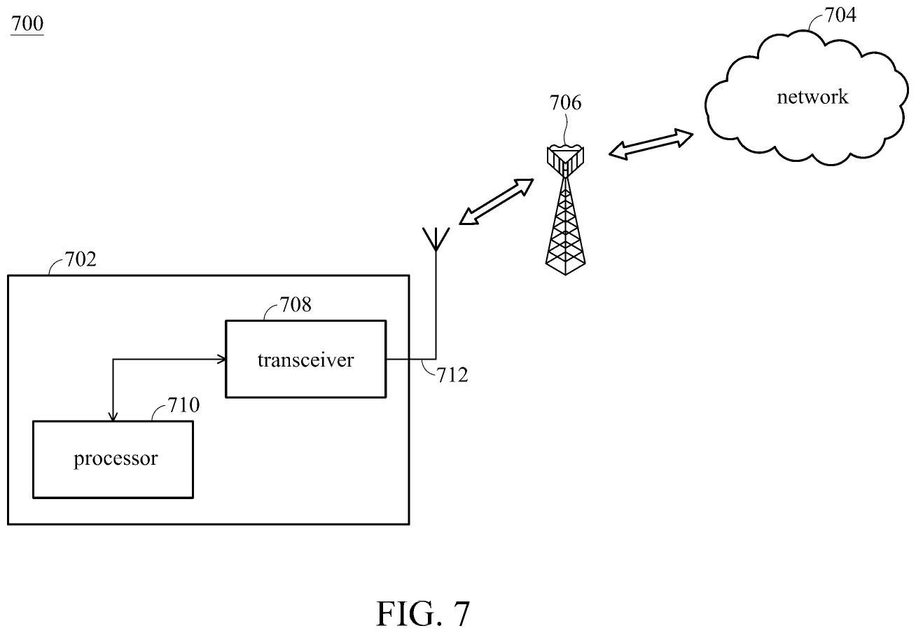

FIG. 7 shows a schematic diagram of a communication system 700 in accordance with some embodiments of the present invention. As shown in FIG. 7, the communication system 700 includes a UE 702, a network 704, and a base station 706. In some embodiments, the UE 702 may be a laptop, a tablet, a smart phone, or a smart watch, but the present invention is not limited thereto. In some embodiments, the UE 702 is able to access the network 704 through the base station 706. The UE 702 is connected with the base station 706 by Radio Resource Control (RRC) signaling, but the present invention is not limited thereto. In some embodiments, the base station 706 may be a gNB, but the present invention is not limited thereto.

In some embodiments, the UE 702 includes an antenna 712, a transceiver 708, and a processor 710. The transceiver 708 is electrically connected between the antenna 712 and the processor 710. The processor 710 may be a modem, but the present invention is not limited thereto. In some embodiments, the UE 702 further includes a memory (not shown) storing a plurality of codes. The processor 710 reads the codes stored in the memory to execute the steps as follows. In some embodiments, the processor 710 runs a NAS signaling wait timer for a duration of time. The processor 710 establishes an emergency protocol data unit (PDU) session during the duration of time, or performs an emergency services fallback procedure during the duration of time. The duration that the NAS signaling wait timer is running starts with a random value up to and including a stored maximum time offset value upon returning in coverage of a tracking area (TA) in a current registration after being out of coverage due to discontinuous coverage. The processor 710 initiates an NAS signaling. In some embodiments, the NAS signaling is a mobility registration update procedure or a tracking area updating procedure, but the present invention is not limited thereto.

In some embodiments, after the discontinuous coverage NAS signaling wait timer is running, the processor 710 receives a request from an upper layer to perform the emergency services fallback procedure. After that, the processor 710 selects an E-UTRAN, a GERAN, or an UTRAN for the emergency services, or it performs an initial registration for the emergency services, or it informs the upper layer of a failure of the emergency services fallback procedure.

In some embodiments, after the discontinuous coverage NAS signaling wait timer is running, the processor 710 has a pending emergency services fallback procedure. After that, the processor 710 selects an E-UTRAN, a GERAN, or an UTRAN for the emergency services, or it performs an initial registration for the emergency services, or it informs the upper layer of a failure of the pending emergency services fallback procedure, or of the signaling procedure, or of the registration procedure.

In some embodiments, after the discontinuous coverage NAS signaling wait timer is running, the processor 710 has an established PDU session. After that, the processor 710 selects an E-UTRAN, a GERAN, or an UTRAN for the emergency services, or it performs an initial registration for the emergency services, or it informs the upper layer of a failure of the established emergency PDU session, or of the signaling procedure, or of the registration procedure.

In some embodiments, the processor 710 is configured for a high-priority access in a selected PLMN. The processor 710 receives and has stored the maximum NAS signaling wait time. After that, the processor 710 does not use the maximum NAS signaling wait time. The processor 710 does not start the NAS signaling wait timer using the maximum NAS signaling wait time.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method to improve emergency services at and after discontinuous coverage, applied to user equipment (UE), comprising:
running a non-access stratum (NAS) signaling wait timer for a duration of time; and
establishing an emergency protocol data unit (PDU) session during the duration of time; or
performing an emergency services fallback procedure during the duration of time, and
initiating an NAS signaling.

2. The method as claimed in claim 1, wherein the NAS signaling is a mobility registration update procedure or a tracking area updating procedure.

3. The method as claimed in claim 1, further comprising:
receiving a request from an upper layer to perform the emergency services fallback procedure; and
selecting an evolved universal terrestrial radio access network (E-UTRAN), a GSM EDGE radio access network (GERAN), or a UMTS terrestrial radio access network (UTRAN) for the emergency services; or
performing an initial registration for the emergency services; or
informing the upper layer of a failure of the emergency services fallback procedure.

4. The method as claimed in claim 1, further comprising:
having a pending emergency services fallback procedure; and
selecting an evolved universal terrestrial radio access network (E-UTRAN), a GSM EDGE radio access network (GERAN), or a UMTS terrestrial radio access network (UTRAN) for the emergency services; or
performing an initial registration for the emergency services; or
informing the upper layer of a failure of the pending emergency services fallback procedure.

5. The method as claimed in claim 1, further comprising:
having an established emergency protocol data unit (PDU) session; and
selecting an evolved universal terrestrial radio access network (E-UTRAN), a GSM EDGE radio access network (GERAN), or a UMTS terrestrial radio access network (UTRAN) for the emergency services; or
performing an initial registration for the emergency services; or
informing the upper layer of a failure of the established emergency PDU session.

6. The method as claimed in claim 1, wherein the duration that the NAS signaling wait timer is running starts with a random value up to and including a stored maximum time offset value upon returning in coverage of a tracking area (TA) in a current registration after being out of coverage due to discontinuous coverage.

7. The method as claimed in claim 1, further comprising:
being configured for a high-priority access in a selected public land mobile network (PLMN); and
receiving and having stored maximum NAS signaling wait time; and
not using the maximum NAS signaling wait time; or
not starting the NAS signaling wait timer using the maximum NAS signaling wait time.

8. A user equipment (UE) to improve emergency services at and after discontinuous coverage, comprising:
a processor, configured to:
run a non-access stratum (NAS) signaling wait timer for a duration of time; and
establish an emergency protocol data unit (PDU) session during the duration of time; or
perform an emergency services fallback procedure during the duration of time, and
initiate an NAS signaling.

9. The UE as claimed in claim 8, wherein after the NAS signaling wait timer has begun running, the processor is configured to:
receive a request from an upper layer to perform the emergency services fallback procedure, and
select an evolved universal terrestrial radio access network (E-UTRAN), a GSM EDGE radio access network (GERAN), or a UMTS terrestrial radio access network (UTRAN) for the emergency services; or
perform an initial registration for the emergency services; or
inform the upper layer of a failure of the emergency services fallback procedure.

10. The UE as claimed in claim 8, wherein after the NAS signaling wait timer has begun running, the processor is configured to:
have a pending emergency services fallback procedure; and
select an evolved universal terrestrial radio access network (E-UTRAN), a GSM EDGE radio access network (GERAN), or a UMTS terrestrial radio access network (UTRAN) for the emergency services; or
perform an initial registration for the emergency services; or
inform the upper layer of a failure of the pending emergency services fallback procedure.

11. The UE as claimed in claim 8, wherein after the NAS signaling wait timer has begun running, the processor is configured to:
have an established emergency protocol data unit (PDU) session; and
select an evolved universal terrestrial radio access network (E-UTRAN), a GSM EDGE radio access network (GERAN), or a UMTS terrestrial radio access network (UTRAN) for the emergency services; or
perform an initial registration for the emergency services; or
inform the upper layer of a failure of the established emergency PDU session.

12. The UE as claimed in claim 8, wherein the NAS signaling is a mobility registration update procedure or a tracking area updating procedure.

13. The UE as claimed in claim 8, wherein the duration that the NAS signaling wait timer is running starts with a random value up to and including a stored maximum time offset value upon returning in coverage of a tracking area (TA) in a current registration after being out of coverage due to discontinuous coverage.

14. The UE as claimed in claim 8, wherein the processor is configured to:
be configured for a high-priority access in a selected public land mobile network (PLMN), and
receive and have stored maximum NAS signaling wait time, and
not to use the maximum NAS signaling wait time; or
not to start the NAS signaling wait timer using the maximum NAS signaling wait time.
